(19) United States
(12) Patent Application Publication
(10) Pub. No.: US 2026/0021787 A1
(43) Pub. Date: Jan. 22, 2026

(54) VEHICLE CONTROL APPARATUS

(71) Applicant: TOYOTA JIDOSHA KABUSHIKI KAISHA, Toyota-shi (JP)

(72) Inventor: Ryo SATO, Toyota-shi (JP)

(73) Assignee: TOYOTA JIDOSHA KABUSHIKI KAISHA, Toyota-shi (JP)

(21) Appl. No.: 19/256,897

(22) Filed: Jul. 1, 2025

(30) Foreign Application Priority Data
Jul. 19, 2024 (JP) 2024-115663

(51) Int. Cl. B60R 25/20; B60R 25/30; G07C 5/02

(52) U.S. Cl. CPC B60R 25/20; B60R 25/305; G07C 5/02

(57) ABSTRACT

A vehicle control apparatus includes an image capturing device, a position information acquisition device, and a processor. The processor of a vehicle control apparatus is configured to execute a recording process of acquiring image data from the image capturing device and storing the image data, and execute a halting process of halting operation of the image capturing device on condition that a vehicle is parked and that the current position of the vehicle is within a predetermined first area. The processor is configured to store a parking point at which the vehicle is parked in a storage device each time the vehicle is parked, estimate an area in which the vehicle is to be parked, based on the distribution of a plurality of the parking points stored in the storage device, and set the area as a new first area.

### CROSS-REFERENCE TO RELATED APPLICATION

This application claims priority to Japanese Patent Application No. 2024-115663 filed on Jul. 19, 2024. The disclosure of the above-identified application, including the specification, drawings, and claims, is incorporated by reference herein in its entirety.

### BACKGROUND

### 1. Technical Field

The present disclosure relates to a vehicle control apparatus.

### 2. Description of Related Art

There has been proposed a vehicle control apparatus (also referred to as “approach surveillance apparatus”, “security apparatus”, or the like in some cases) that includes a function (approach surveillance function) of capturing and recording an image of an object when the object approaches a parked own vehicle (for example, see Japanese Unexamined Patent Application Publication No. 2013-119369 (JP 2013-119369 A)). The vehicle control apparatus (hereinafter, referred to as “conventional apparatus”) includes a function of disabling the approach surveillance function (a function of setting an image capturing device to halt and refrain from recording) when the own vehicle is parked in a specified area. A driver registers, as the specified area, an area (for example, a parking spot at home) where it is less likely that an unrelated person approaches the own vehicle. Thus, when the own vehicle is parked in the specified area, the image capturing device is halted, whereby electricity consumed by the image capturing device, memory (a device that stores image data), and the like can be reduced.

### SUMMARY

When the conventional apparatus detects that a predetermined registration operation (for example, an operation of depressing a registration button) is performed in a state where the own vehicle is parked, the conventional apparatus registers (stores), as a specified area, a predetermined area including a point at which the own vehicle is parked. Here, the specified area is a circular area having its center at the longitude and latitude of a predetermined point (for example, the center of gravity) of the own vehicle at the time when the registration operation is performed. The size (radius) of the circular area is a fixed value that is determined at a stage of designing the vehicle control apparatus. Accordingly, for example, when the radius (design value) of the specified area is relatively small, the driver may park the own vehicle slightly out of the specified area, so that the approach surveillance function is not disabled, and the amount of electricity consumed by the image capturing device and the like cannot be reduced, in some cases. In contrast, when the radius (design value) of the specified area is relatively large, there are some cases where the approach surveillance function is disabled (the image capturing device is halted), despite the intention by the driver. For example, when a parking spot for a shop next to the own home is included in the specified area (for example, a circular area having its center at the center of the parking spot at home), and when the vehicle is parked in the parking spot for the shop, the approach surveillance function is disabled.

The present disclosure provides a vehicle control apparatus that can restrain recording from being performed despite the intention by a user, and/or restrain recording from being cancelled despite the intention by a user.

A vehicle control apparatus of the present disclosure includes: an image capturing device configured to capture an area surrounding a vehicle and acquire image data; a position information acquisition device configured to acquire information related to the current position of the vehicle; and a processor configured to execute a recording process of acquiring the image data from the image capturing device and storing the image data, and execute a halting process of halting operation of the image capturing device, on condition that the vehicle is parked and that the current position of the vehicle is within a predetermined first area. The processor is configured to store a parking point at which the vehicle is parked in a storage device each time the vehicle is parked, estimate an area in which the vehicle is to be parked, based on the distribution of a plurality of the parking points stored in the storage device, and set the area as a new first area.

The processor of the vehicle control apparatus according to the present disclosure optimizes the first area (area in which the halting process is executed), based on the distribution of the past parking points. Thus, it is possible to restrain recording from being performed despite the intention by a user (driver), and/or restrain recording from being cancelled despite the intention by a user.

The processor may be configured to set the new first area, based on the distribution of the parking points within the current first area and within a predetermined second area adjacent to the current first area.

With the above configuration, it is possible to exclude a parking point that is far from the current first area (a parking point that is likely to be irrelevant to the area where the vehicle is parked frequently), and to optimize the first area, based on the distribution of the remaining parking points.

The processor may be configured to, when the vehicle is parked within the second area, provide a driver of the vehicle with information that is used for the driver to choose whether to execute the halting process and, when the driver performs a predetermined choosing operation, execute the halting process.

There are some cases where the parking point of the vehicle is slightly out of the first area even if the driver intends to park the vehicle within the first area. Moreover, there are some cases where the vehicle needs to be parked at a point slightly outside the first area because the vehicle cannot be parked within the first area for any reason. The vehicle control apparatus in the above configuration allows the driver to choose whether to execute the halting process when the parking point of the vehicle is slightly out of the first area.

The second area may be an annular area surrounding the first area, and the processor may be configured to set the width of the second area in such a manner that the larger the first area is, the greater the width is.

In this case, for example, the ratio of the width of the second area to the first area may be constant.

With the above configuration, the width of the second area is appropriately set, according to the size of the first area.

The vehicle control apparatus may include an operation device for designating the size of the second area. The operation device may be configured to output predetermined information according to an operational aspect. The processor may be configured to determine the size of the second area, based on the information acquired from the operation device.

With the above configuration, the size of the second area is set as the driver intends.

The processor may be configured to set, as the new first area, the smallest circular area including all the parking points within the first area, on condition that the number of the parking points within the first area coincides with a first threshold value and that the number of the parking points within the second area is zero.

With the above configuration, the first area can be narrowed to an area in which the vehicle is more likely to be parked.

The processor may be configured to set, as the new first area, the smallest circular area including all the parking points within the first area and the second area, on condition that the number of the parking points within the second area coincides with a second threshold value.

With the above configuration, the first area can be expanded to an area in which the vehicle is likely to be parked.

The processor may be configured not to change the position of the center of the first area.

With the above configuration, an area that is a circumferential portion of the old first area (first area before optimization is performed) and in which the vehicle is less likely to be parked can be excluded from the first area.

The processor may be configured to set, as the new first area, a circular area having its center at the average values of the longitudes and latitudes of all the parking points within the first area.

With the above configuration, when the parking points are unevenly distributed within the old first area (first area before optimization is performed), an area as described above can be set as the new first area.

The processor may be configured to set, as the new first area, a circular area having a predetermined size and having its center at the average values of the longitudes and latitudes of a plurality of the parking points that are within the second area and at which the driver chooses to execute the halting process, on condition that the number of the plurality of the parking points coincides with a third threshold value.

When the driver chooses to halt the image capturing device in the second area with high frequency, it is likely that the vehicle will be parked at the parking points where such choice is made, or in their vicinities. The vehicle control apparatus in the above configuration enables an area in which the vehicle is likely to be parked to be set as the new first area.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram of a vehicle control apparatus according to an embodiment of the present disclosure;

FIG. 2 is a plan view showing a first example in which a first area and a second area are scaled up;

FIG. 3 is a plan view showing a second example in which the first area and the second area are scaled up;

FIG. 4 is a plan view showing an example in which the first area and the second area are scaled down;

FIG. 5 is a flowchart of a first program that is executed by a CPU to implement various functions of the vehicle control apparatus;

FIG. 6 is a flowchart of a second program that is executed by the CPU to implement various functions of the vehicle control apparatus;

FIG. 7 is a flowchart of a third program that is executed by the CPU to implement various functions of the vehicle control apparatus;

FIG. 8 is a plan view showing a first example in which a registration point is reset based on the distribution of parking points; and

FIG. 9 is a plan view showing a second example in which the registration point is reset based on the distribution of parking points.

### DETAILED DESCRIPTION OF EMBODIMENTS

### Outline

A vehicle control apparatus 1 according to an embodiment of the present disclosure is applied to, for example, a vehicle V0 (hereinafter, simply referred to as “vehicle”) including an autonomous driving function. For example, the vehicle control apparatus 1 is mounted in the vehicle. The vehicle control apparatus 1 includes a function (hereinafter, referred to as “approach surveillance function”) of capturing and recording an image of an object when the vehicle control apparatus 1 detects that the object approaches the parked vehicle. Moreover, the vehicle control apparatus 1 includes a function of disabling the approach surveillance function when the vehicle is parked within a specified area (first area A1, which will be described later). Further, the vehicle control apparatus 1 includes a function of updating (optimizing) the specified area, based on the distribution of points at which the vehicle was parked recently.

### Specific Configuration

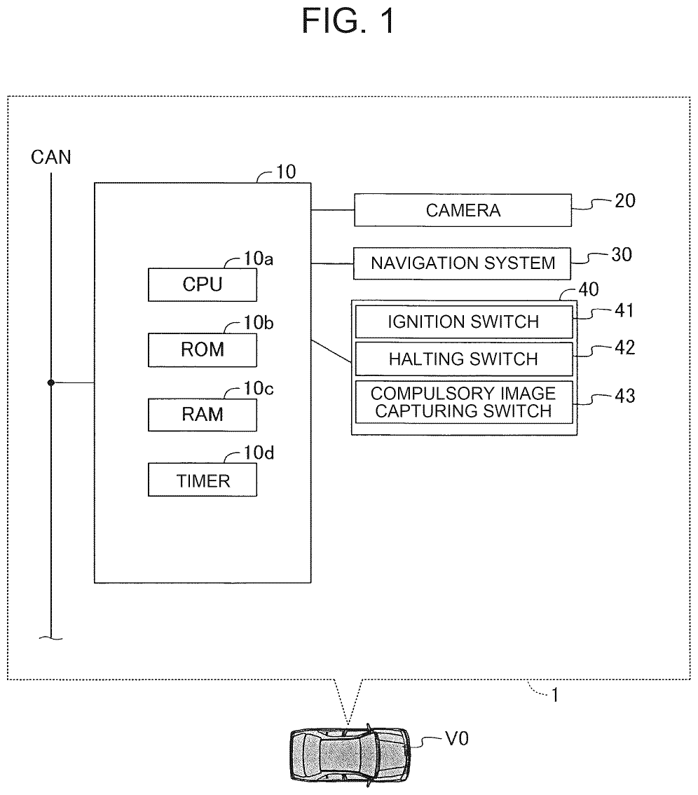

As shown in FIG. 1, the vehicle control apparatus 1 includes an ECU 10, a camera 20, a navigation system 30, and an operation device 40.

The ECU 10 includes a microcomputer that includes a CPU 10a, a ROM 10b, a RAM 10c, a timer 10d, and the like. The ROM 10b includes, for example, a mass storage device configured by using NAND flash memory. The ECU 10 is connected to another ECU included in the vehicle, via a controller area network (CAN).

The camera 20 is configured by using a plurality of image capturing devices. Each image capturing device incorporates a lens, an image capturing element (for example, CCD), and the like. The image capturing devices are installed at a front portion, a rear portion, a right-side portion, and a left-side portion of the vehicle, respectively. The image capturing devices capture a surrounding area around the vehicle at a predetermined frame rate and acquire image data. Each image capturing device provides the acquired image data to the ECU 10. Supply of electricity to each image capturing device is controlled by the ECU 10. The ECU 10 interrupts supply of electricity to each image capturing device when a predetermined condition is satisfied. Thus, operation of each image capturing device is halted.

The navigation system 30 includes an antenna, a display device, and a controller. For example, the antenna is attached to front windshield glass of the vehicle. The antenna receives GPS signals from a plurality of GPS satellites and supplies the GPS signals to the controller. The display device displays an image in accordance with an instruction acquired from the controller. The controller acquires the current position (longitude and latitude) of the vehicle, based on the GPS signals acquired from the antenna. The controller stores map information. The controller causes the display device to display the current position and a map of the vicinity of the current position, based on the map information.

The operation device 40 includes various switches that are operated by a driver. Specifically, the operation device 40 includes an ignition switch 41. For example, the ignition switch 41 is configured by using a rotary switch device. When the ignition switch 41 shifts from an off state to an on state, a power train (for example, an engine, a motor) of the vehicle is started. In contrast, when the ignition switch 41 shifts from the on state to the off state, the power train is stopped.

Further, the operation device 40 includes a halting switch 42 used to request the ECU 10 to execute a halting process, which will be described later. The halting switch 42 is configured by using a press-button switch device. The ECU 10 monitors the on and off states of the switches.

### Recording Function

The ECU 10 controls a power supply device of the vehicle in such a manner that electricity is supplied to each image capturing device of the camera 20 when the ignition switch 41 is in the on state. The ECU 10 executes a normal recording process of acquiring image data from each image capturing device in each predetermined period (at the predetermined frame rate) and storing the image data in the ROM 10b (mass storage). Such operation is referred to as “normal mode”. Even when the ignition switch 41 is in the off state, that is, even when the vehicle is parked, the ECU 10 controls the power supply device in such a manner that electricity is supplied to each image capturing device as a rule. The ECU 10 acquires image data from each image capturing device in each predetermined period, analyzes the image data, and recognizes (identifies) a target appearing in each image. Specifically, the ECU 10 recognizes a moving object, such as a pedestrian or another vehicle that is different from the vehicle equipped with the vehicle control apparatus 10. The ECU 10 identifies a moving object approaching the vehicle and another object, based on changes in image size and position of the moving object. When the ECU 10 detects that the moving object approaches the vehicle, the ECU 10 stores the relevant image data in the ROM 10b. A process of identifying and recording a moving object that approaches the vehicle is referred to as “approach surveillance process”. An operation mode for the approach surveillance process is referred to as “approach surveillance mode”. When a moving object approaching the vehicle does not exist, the ECU 10 discards the acquired image data, without storing it in the ROM 10b. Thus, a decrease in space of the ROM 10b is restrained in a state where the vehicle is parked. Moreover, the number of times a process of writing image data into the ROM 10b is executed is reduced. Accordingly, electricity consumed by the CPU 10a and the ROM 10b is reduced, compared to in the normal mode.

### Halting Function

When the ECU 10 detects that the ignition switch 41 shifts from the on state to the off state, that is, the vehicle is parked, the ECU 10 acquires, from the navigation system 30, information related to the current position of the vehicle, for example, the coordinates, such as the longitude and latitude, of a parking point P at which the vehicle is parked. When the ECU 10 detects, based on the information, that the vehicle is parked in a predetermined first area A1, the ECU 10 interrupts supply of electricity to each image capturing device of the camera 20. In other words, when the ECU 10 detects that the vehicle is parked and that the current position of the vehicle is within the first area A1, the ECU 10 halts operation of each image capturing device of the camera 20. This process is referred to as “halting process”. An operation mode for a state where the camera 20 is halted as a result of the halting process is referred to as “halt mode”. The driver can register the first area A1 as follows. For example, when the driver parks the vehicle in a parking spot SP0 provided on home property and depresses an undepicted registration button, the ECU 10 stores, as the first area A1, a circular area having its center O at the center of gravity of the vehicle. Hereinafter, the center O of the first area A1 at the time of registration is referred to as the registration point P0. Note that the ECU 10 assigns a relatively large initial value Rini (for example, Rini=20 meters) to the radius R1 of the first area A1 at the time of registration such that the parking spot SP0 is included within the first area A1. In other words, initial values of the center O, the radius R1, and the like of the first area A1 are set in response to an operation of the registration button. The ECU 10 optimizes the size of the first area A1 as appropriate, which will be described in detail later. In other words, the radius R1 of the first area A1 is updated as appropriate.

### Setting Requesting Function

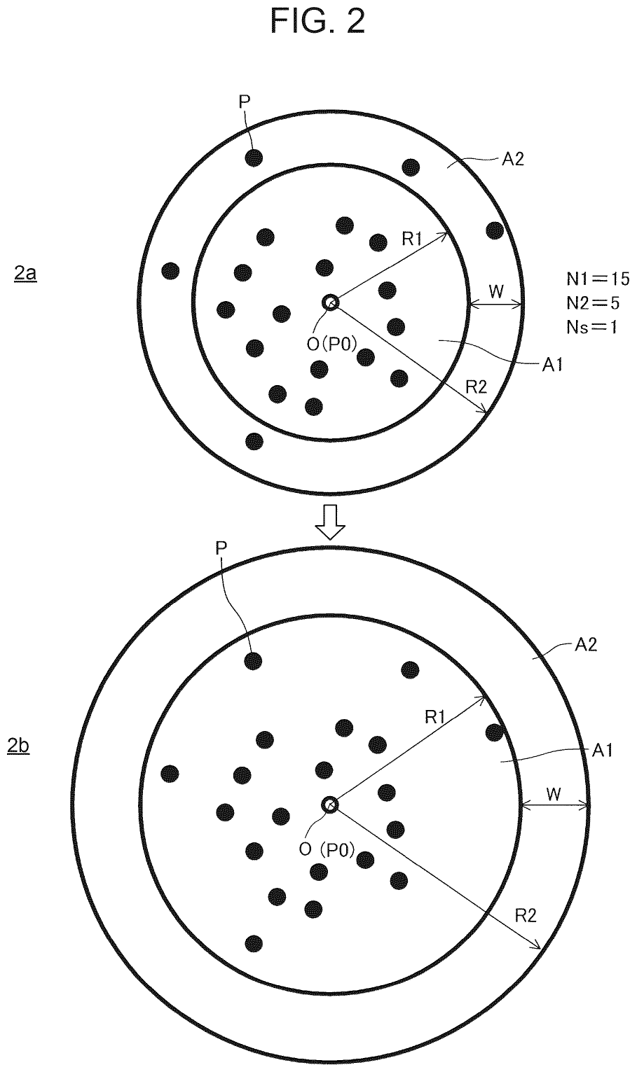

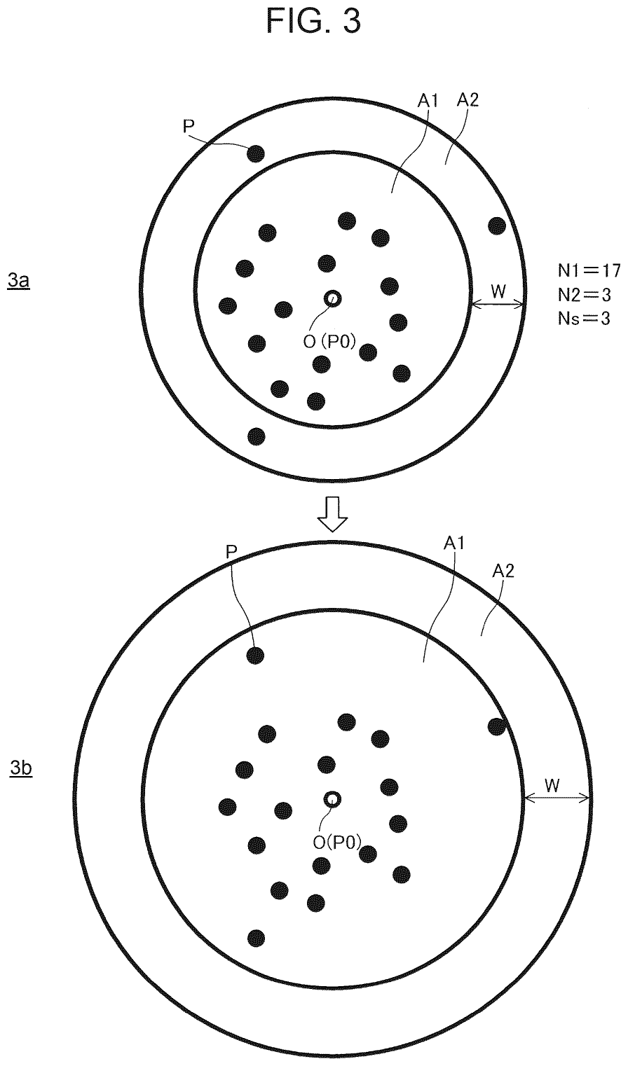

Incidentally, there are some cases where the driver parks the vehicle slightly out of the first area A1. In such a case, even if a moving object approaches the parked vehicle, there is no great need for recording the moving object in some cases. Accordingly, when the vehicle is parked in the vicinity of the first area A1, the ECU 10 executes a setting requesting process of presenting, to the driver, information used to choose whether to halt the camera 20. Specifically, as shown in FIG. 2, FIG. 3, and others, the ECU 10 sets an annular area surrounding the first area A1, as a second area A2. The second area A2 is adjacent to the first area A1. The center O of the second area A2 coincides with the center O of the first area A1. The ratio r of the outer radius R2 of the second area A2 to the radius R1 of the first area A1, r=R2/R1, is, for example, “1.3”. When the vehicle is parked within the second area A2 (when the parking point P, which is the center of gravity of the vehicle, is included within the second area A2), the ECU 10 causes the display device of the navigation system 30 to display a predetermined image (icon). The ECU 10 causes the image to be deleted when a predetermined time period has passed since the display of the image was started. The ECU 10 halts the camera 20 when the ECU 10 detects that the halting switch 42 is depressed while the image is being displayed.

### Optimization Function

The ECU 10, based on the distribution of a plurality of recent (past) parking points P, estimates an area in which the vehicle is likely to be parked, and based on a result the estimation, executes an optimization process of changing the size of the first area A1. Specifically, each time the vehicle is parked within the first area A1 or the second area A2, the ECU 10 stores the coordinates of the parking point P (hereinafter, referred to as “parking point information”) in the ROM 10b. Note that the parking point information is stored as time-series data in a predetermined storage area that is provided in the ROM 10b and that is an area other than the area where the image data is stored. The predetermined storage area is a ring buffer RB in the present embodiment. For example, the ring buffer RB has a storage capacity that can store 20 pieces of parking point information. When new parking point information is stored in the ring buffer RB in a state where parking point information is stored in every storage area of the ring buffer RB, the oldest parking point information is deleted, and the new parking point information is stored in the storage area where the deleted parking point information has been stored.

### Scaling-Up Process

When frequency is high with which the vehicle is parked in the second area A2, there is a possibility that the first area A1 is too small. For example, when an area is relatively large that is in home property and where the vehicle can be parked, there is a possibility that the vehicle is parked in the second area A2 with high frequency. Accordingly, when the vehicle is parked in the second area A2, the ECU 10 refers to the ring buffer RB and counts the number N2 of parking points P included within the second area A2. The number N2 means the number of times the vehicle was parked in the second area A2 recently. When the number N2 coincides with a threshold value N2th (N2th=5 in state 2a in FIG. 2), the ECU 10 acquires, as a new first area A1, the smallest circular area that includes all the parking points P within the second area A2 (state 2b in FIG. 2). In this case, the ECU 10 scales up the first area A1. In a scaling-up process for the first area A1, the ECU 10 does not change the position of the center O (registration point P0) of the first area A1. With the scaling-up of the first area A1, the ECU 10 scales up the second area A2. In other words, the ECU 10 increases the outer radius R2, without changing the position of the center O of the second area A2. The ratio r of the outer radius R2 of the second area A2 to the radius R1 of the first area A1 (r=R2/R1) is always constant. Accordingly, when the first area A1 is scaled up, the width W of the second area A2 is made greater.

When frequency is high with which the driver chooses to halt the camera 20 when the vehicle is parked in the second area A2, it is likely that the driver feels that the first area A1 is too small. Accordingly, when the driver chooses to halt the camera 20 with high frequency even if the number of times the vehicle is parked within the second area A2 does not reach the threshold value N2th, the ECU 10 scales up the first area A1. Specifically, the ECU 10 counts the number of times Ns the driver chooses to halt the camera 20. Each time the driver depresses the halting switch 42, the ECU 10 increases the number of times Ns in an increment of one. The number of times Ns is set (initialized) to “zero” when the registration button is depressed at a time of registration of the first area A1. When the number of times Ns increases and coincides with a threshold value Nsth (for example, Nsth=3<N2th=5) as in state 3a in FIG. 3, the ECU 10 acquires, as a new first area A1, the smallest circular area that includes all parking points P (including a parking point P at which the driver does not choose to halt the camera 20) within the second area A2 (state 3b in FIG. 3). By the driver proactively choosing to halt the camera 20 when the vehicle is parked within the second area A2 as described above, execution of the scaling-up process for the first area A1 is promoted. At the time when the first area A1 is scaled up, the ECU 10 sets (initializes) the number of times Ns to “zero”.

### Scaling-Down Process

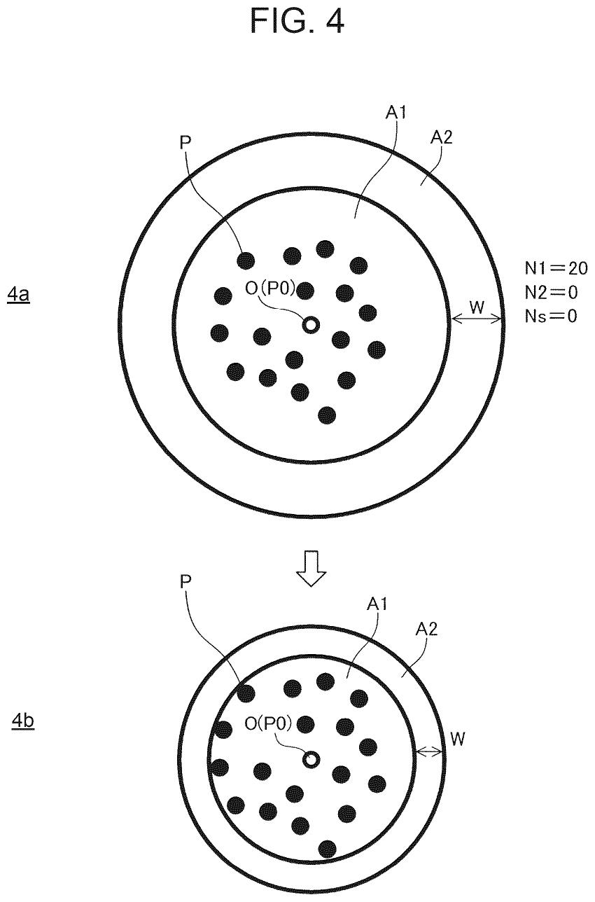

In contrast, when the vehicle is parked in the first area A1, the ECU 10 refers to the ring buffer RB and counts the number N1 of parking points P included within the first area A1 and the number N2 of parking points P included within the second area A2. When the number N1 of parking points P included within the first area A1 coincides with a threshold value N1th (N1th=20 (the maximum number of pieces of information that can be stored in the ring buffer RB) in state 4a in FIG. 4), and when the number N2 of parking points P included within the second area A2 is “zero” (state 4a in FIG. 4), the ECU 10 acquires, as a new first area A1, the smallest circular area that includes all the parking points P within the first area A1 (state 4b in FIG. 4). In this case, the ECU 10 scales down the first area A1. When a parking point P exists on the circumference of the first area A1, the first area A1 is not changed. In the scaling-down process for the first area A1, the ECU 10 does not change the position of the center O of the first area A1. With the scaling-down of the first area A1, the ECU 10 scales down the second area A2. In other words, the ECU 10 reduces the outer radius R2, without changing the position of the center O of the second area A2. The ratio r of the outer radius R2 of the second area A2 to the radius R1 of the first area A1 is always constant. Accordingly, when the first area A1 is scaled down, the width W of the second area A2 is reduced.

Parking point information related to a point (for example, a shopping mall) that is far from the registration point P0 (for example, home) is not appropriate for data used to optimize the first area A1. Accordingly, when the vehicle is parked outside the second area A2 (on the opposite side to the first area A1), the ECU 10 does not store parking point information related to the relevant parking point P.

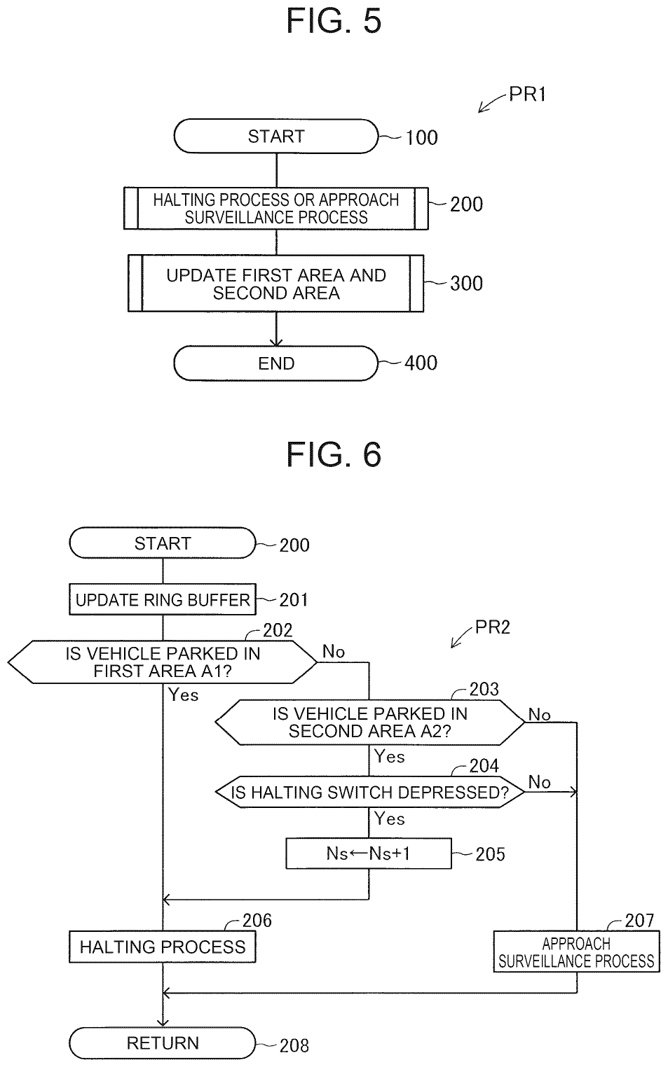

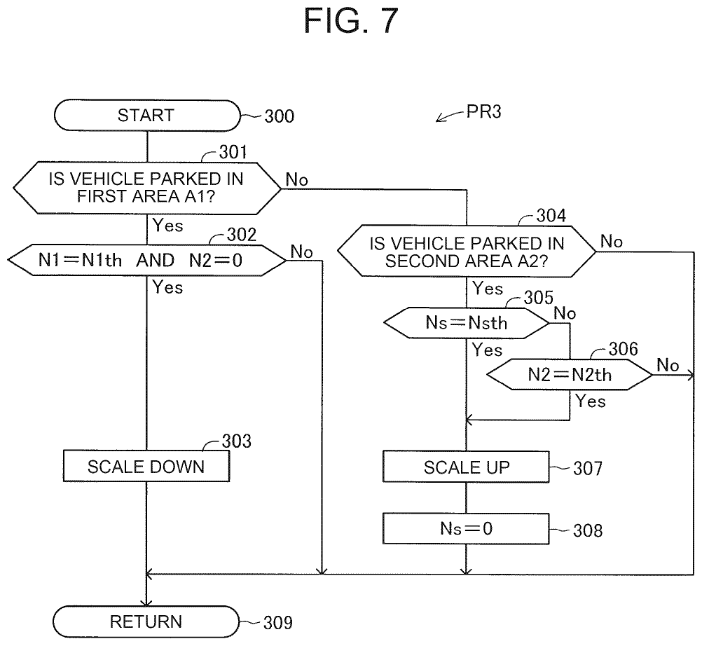

With reference to FIGS. 5 to 7, a description is given of programs PR1, PR2, PR3 that the CPU 10a (hereinafter, simply referred to as “CPU”) executes to implement the functions of the vehicle control apparatus 1 (the functions provided when the vehicle is parked (excluding the function of registering the parking spot SP0)). Note that the programs PR2 and PR3 are subroutines of the program PR1. The CPU executes the program PR1 when it is detected that the ignition switch 41 shifts from the on state to the off state.

### Program PR1

The CPU starts executing the program PR1 from step 100 and moves to step 200.

In step 200, the CPU executes the program PR2, which will be described later, and starts the halting process or the approach surveillance process. Next, the CPU moves to step 300.

In step 300, the CPU executes the program PR3, which will be described later, and updates the first area A1 and the second area A2. Next, the CPU moves to step 400, and in step 400, terminates the execution of the program PR1.

### Program PR2

The CPU starts executing the program PR2 from step 200 and moves to step 201.

In step 201, the CPU updates the ring buffer RB. In other words, the CPU stores parking point information related to a current parking point P in the ring buffer RB. Next, the CPU moves to step 202.

In step 202, the CPU determines whether the vehicle is parked in the first area A1 (whether the current parking point P is included within the first area A1). When the CPU determines that the vehicle is parked in the first area A1 (202: Yes), the CPU moves to step 206, which will be described later. In contrast, when the CPU does not determine that the vehicle is parked in the first area A1 (202: No), the CPU moves to step 203.

In step 203, the CPU determines whether the vehicle is parked in the second area A2 (whether the current parking point P is included within the second area A2). When the CPU determines that the vehicle is parked in the second area A2 (203: Yes), the CPU moves to step 204. In contrast, when the CPU does not determine that the vehicle is parked in the second area A2 (203: No), the CPU moves to step 207.

In step 204, the CPU causes the display device to display the predetermined image, and determines whether the halting switch 42 is depressed during the display. When the CPU determines that the halting switch 42 is depressed (204: Yes), the CPU moves to step 205. When the CPU does not determine that the halting switch 42 is depressed (204: No), the CPU moves to step 207.

In step 205, the CPU increments the number of times Ns the halting switch 42 is depressed in an increment of one. Next, the CPU moves to step 206.

When the CPU moves to step 206, the CPU executes the halting process. When the CPU moves to step 207, the CPU executes (starts) the approach surveillance process. Next, the CPU moves to step 208, returns to the program PR1, and moves to step 300.

### Program PR3

The CPU starts executing the program PR3 from step 300 and moves to step 301.

In step 301, the CPU determines whether the vehicle is parked in the first area A1 (whether the current parking point P is included within the first area A1). When the CPU determines that the vehicle is parked in the first area A1 (301: Yes), the CPU moves to step 302. In contrast, when the CPU does not determine that the vehicle is parked in the first area A1 (301: No), the CPU moves to step 304.

In step 302, the CPU determines whether a condition X below is satisfied.

Condition X: the number N1 coincides with the threshold value N1th, and the number N2 is “zero”.

When the CPU determines that the condition X is satisfied (302: Yes), the CPU moves to step 303. When the CPU does not determine that the condition X is satisfied (302: No), the CPU moves to step 309, returns to the program PR1, and moves to step 400.

In step 303, the CPU executes the scaling-down process. Next, the CPU moves to step 309, returns to the program PR1, and moves to step 400.

In step 304, the CPU determines whether the vehicle is parked in the second area A2 (whether the current parking point P is included within the second area A2). When the CPU determines that the vehicle is parked in the second area A2 (304: Yes), the CPU moves to step 305. When the CPU does not determine that the vehicle is parked in the second area A2 (304: No), the CPU moves to step 309, returns to the program PR1, and moves to step 400.

In step 305, the CPU determines whether a condition Y below is satisfied.

Condition Y: the number of times Ns coincides with the threshold value Nsth.

When the CPU determines that the condition Y is satisfied (305: Yes), the CPU moves to step 307. When the CPU does not determine that the condition Y is satisfied (305: No), the CPU moves to step 306.

In step 306, the CPU determines whether a condition Z below is satisfied.

Condition Z: the number N2 coincides with the threshold value N2th.

When the CPU determines that the condition Z is satisfied (306: Yes), the CPU moves to step 307. When the CPU does not determine that the condition Z is satisfied (306: No), the CPU moves to step 309, returns to the program PR1, and moves to step 400.

In step 307, the CPU executes the scaling-up process. Next, the CPU moves to step 308.

In step 308, the CPU sets the number of times Ns to “zero”. Next, the CPU moves to step 309, returns to the program PR1, and moves to step 400.

### Advantageous Effect

The ECU 10 of the vehicle control apparatus 1 optimizes the first area A1 (area in which the halting process is executed), based on the distribution of recent (past) parking points P. Thus, it is possible to restrain recording from being performed despite the intention by a user, and to restrain recording from being canceled despite the intention by a user.

### Modification Example 1

In the embodiment, the size (width W) of the second area A2 is set according to the size (radius R1) of the first area A1. Alternatively, the width W of the second area A2 may be fixed. In this case, the size (width W (fixed value)) of the second area A2 may be settable by the driver. When a relatively large width W is set, the setting requesting process is more likely to be executed because the probability of the vehicle being parked in the second area A2 increases.

### Modification Example 2

In the embodiment, the ratio r of the outer radius R2 of the second area A2 to the radius R1 of the first area A1 is fixed. Alternatively, the ratio r may be settable by the driver operating a predetermined operation device.

### Modification Example 3

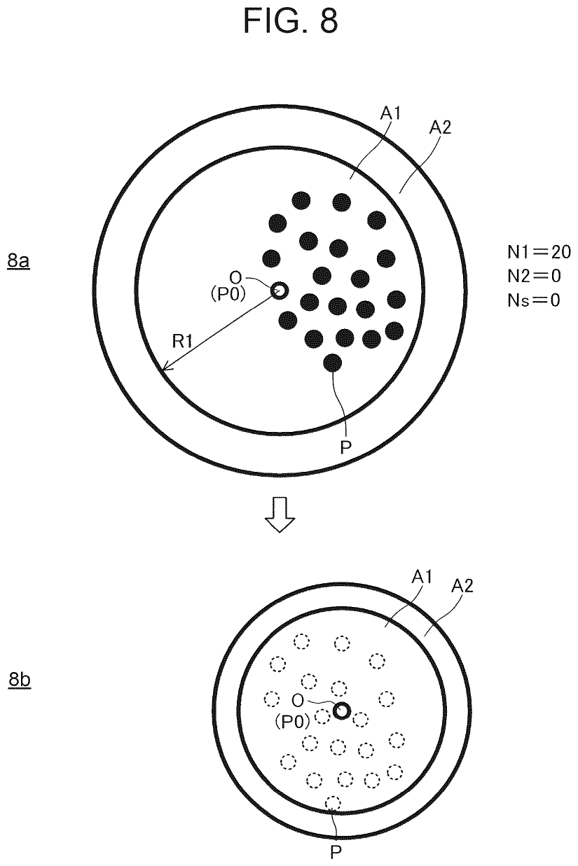

In the embodiment, in optimization of the first area A1, the coordinates of the center O of the first area A1 is not changed. Alternatively, the coordinates of the center O may be changed, based on the distribution of parking points P. In other words, the registration point P0 may be reset (adjusted). For example, as shown in FIG. 8, when all parking points P are included within the first area A1 (state 8a), the ECU 10 may calculate the average values of the longitudes and latitudes, that is, the center of gravity, of the parking points P within the first area A1, and may acquire, as a new first area A1, a circular area having its center O (adjusted registration point P0) at the average values (state 8b). In this case, the new first area A1 may be the smallest circular area that includes all the parking points P within the old first area A1.

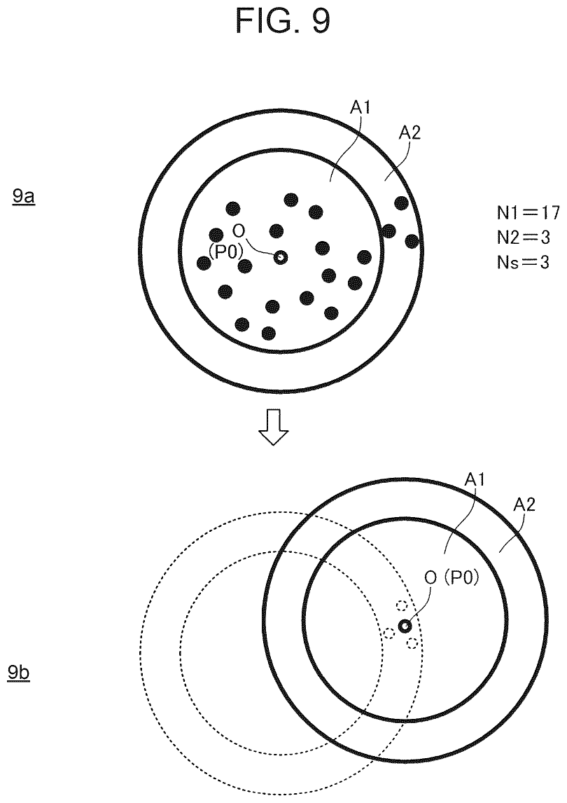

For example, when the number N2 of parking points P included within the second area A2 coincides with the threshold value N2th, or when the number of times Ns the halting switch 42 is depressed coincides with the threshold value Nsth (an example of a third threshold value in the present disclosure) (see FIG. 9), the ECU 10 may calculate the average values of the longitudes and latitudes of the parking points P within the second area A2, that is, the center of gravity of the parking points P. The ECU 10 may acquire, as a new first area A1, a circular area having its center O (adjusted registration point P0) at the center of gravity of the parking points P. In an example shown in FIG. 9, the ECU 10 adopts a preset initial value as the radius R1 of the new first area A1. Alternatively, for example, the ECU 10 may calculate the average value of the distances Δd between the new center O and the parking points P within the second area A2 before the adjustment. The ECU 10 may adopt a value obtained by adding a predetermined margin (fixed value) to the average value, as the radius R1 of the new first area A1. When the registration point P0 is adjusted, all parking point information stored in the ring buffer RB may be cleared.

### Modification Example 4

A plurality of parking spots may be registrable that is used frequently and where it is less likely that a large number of unspecified unrelated persons approach the vehicle. In this case, for each registration point P0, the driver may be able to choose whether to optimize a first area A1 corresponding to the point.

### Modification Example 5

The function of executing the scaling-up process and the setting requesting function in the embodiment may be omitted. In other words, the vehicle control apparatus 1 may include only the function of executing the scaling-down process. In this case, for an initial value of the radius R1 of the first area A1, a relatively large value (for example, 100 meters) may be assigned. Thus, the second area A2 can be omitted.

### Modification Example 6

An operational aspect of the image capturing device (whether to halt the image capturing device) in a state where the vehicle is parked in the first area A1 may be selectable by the driver. For example, the vehicle control apparatus 1 may include a compulsory image capturing switch 43. When the compulsory image capturing switch 43 is in an on state, the ECU 10 may be configured not to halt the camera 20 even if the vehicle is parked in the first area A1. In this case, the second area A2 is not set.

### Modification Example 7

A vehicle control apparatus according to another aspect of the present disclosure includes: an image capturing device configured to capture an area surrounding a vehicle and acquire image data; a position information acquisition device configured to acquire information related to the current position of the vehicle; and a processor configured to execute a recording process of acquiring the image data from the image capturing device and storing the image data, and execute a halting process of halting operation of the image capturing device on condition that the vehicle is parked and that the current position of the vehicle is within a predetermined first area. The processor does not halt the image capturing device even when the vehicle is parked in the first area, on condition that an operation mode is set to a compulsory image capturing mode by a driver of the vehicle operating a predetermined operation device.

Thus, the driver can select an operational aspect of the image capturing device (whether to halt the image capturing device) in a state where the vehicle is parked in the first area.

What is claimed is:

1. A vehicle control apparatus comprising:
an image capturing device configured to capture an area surrounding a vehicle and acquire image data;
a position information acquisition device configured to acquire information related to a current position of the vehicle; and
a processor configured to
execute a recording process of acquiring the image data from the image capturing device and storing the image data, and
execute a halting process of halting operation of the image capturing device on condition that the vehicle is parked and that the current position of the vehicle is within a predetermined first area,
wherein the processor is configured to
store a parking point at which the vehicle is parked in a storage device each time the vehicle is parked,
estimate an area in which the vehicle is to be parked, based on a distribution of a plurality of the parking points stored in the storage device, and
set the area as a new first area.

2. The vehicle control apparatus according to claim 1, wherein the processor is configured to set the new first area, based on a distribution of the parking points within the current first area and within a predetermined second area adjacent to the current first area.

3. The vehicle control apparatus according to claim 2, wherein the processor is configured to
when the vehicle is parked within the second area, provide a driver of the vehicle with information that is used for the driver to choose whether to execute the halting process, and,
when the driver performs a predetermined choosing operation, execute the halting process.

4. The vehicle control apparatus according to claim 2, wherein:
the second area is an annular area surrounding the first area; and
the processor is configured to set a width of the second area in such a manner that the larger the first area is, the greater the width is.

5. The vehicle control apparatus according to claim 2, comprising an operation device for designating a size of the second area, the operation device being configured to output predetermined information according to an operational aspect,
wherein the processor is configured to determine the size of the second area, based on the information acquired from the operation device.

6. The vehicle control apparatus according to claim 2, wherein the processor is configured to set, as the new first area, a smallest circular area including all the parking points within the first area, on condition that the number of the parking points within the first area coincides with a first threshold value and that the number of the parking points within the second area is zero.

7. The vehicle control apparatus according to claim 2, wherein the processor is configured to set, as the new first area, a smallest circular area including all the parking points within the first area and the second area, on condition that the number of the parking points within the second area coincides with a second threshold value.

8. The vehicle control apparatus according to claim 6, wherein the processor is configured not to change a position of a center of the first area.

9. The vehicle control apparatus according to claim 2, wherein the processor is configured to set, as the new first area, a circular area having a center at average values of longitudes and latitudes of all the parking points within the first area.

10. The vehicle control apparatus according to claim 2, wherein the processor is configured to set, as the new first area, a circular area having a predetermined size and having a center at average values of longitudes and latitudes of a plurality of the parking points that are within the second area and at which a driver of the vehicle chooses to execute the halting process, on condition that the number of the plurality of the parking points coincides with a third threshold value.
